(19) United States
(12) Patent Application Publication
(10) Pub. No.: US 2026/0113123 A1
(43) Pub. Date: Apr. 23, 2026

(54) RESONATORS TO TRACK AND CONTROL MODE-LOCKED LASER DIODES

(71) Applicant: NVIDIA Corp., Santa Clara, CA (US)

(72) Inventors: Benjamin Giles Lee, Ridgefield, CT (US); Mir Ashkan Seyedi, Los Gatos, CA (US); Thomas Hastings Greer III, Chapel Hill, NC (US)

(73) Assignee: NVIDIA Corp., Santa Clara, CA (US)

(21) Appl. No.: 18/924,881

(22) Filed: Oct. 23, 2024

(51) Int. Cl. H04B 10/61; H04B 10/50

(52) U.S. Cl. CPC H04B 10/615; H04B 10/503

(57) ABSTRACT

Systems including a first resonator and a second resonator disposed along a waveguide at an output of at least one laser configured to generate a multi-channel optical spectrum, and logic configured to tune the first resonator to a first sideband channel of a multi-channel optical spectrum, tune the second resonator to a second sideband channel of the multi-channel optical spectrum, monitor the first resonator and the second resonator for a common mode wavelength signal of the first sideband channel and the second sideband channel, and apply the common mode wavelength signal to control resonant frequencies of resonators of an optical receiver.

### BACKGROUND

Laser sources such as comb lasers are commonly utilized to communicate dense arrangements of optical channels over waveguides. The wavelength spectrum and power spectrum of the channels may drift over time in different manners due to environmental factors, complicating the problem of maintaining the calibration of transmitters and receivers on the waveguide.

### BRIEF DESCRIPTION OF THE SEVERAL VIEWS OF THE DRAWINGS

To easily identify the discussion of any particular element or act, the most significant digit or digits in a reference number refer to the figure number in which that element is first introduced.

FIG. 1 depicts a comb laser in one embodiment.

FIG. 2 depicts a dense wave division multiplexed (DWDM) transceiver in one embodiment.

FIG. 3 illustrates an aspect of the subject matter in accordance with one embodiment.

FIG. 4 depicts a control process in accordance with one embodiment.

FIG. 5 depicts a control process in accordance with one embodiment.

### DETAILED DESCRIPTION

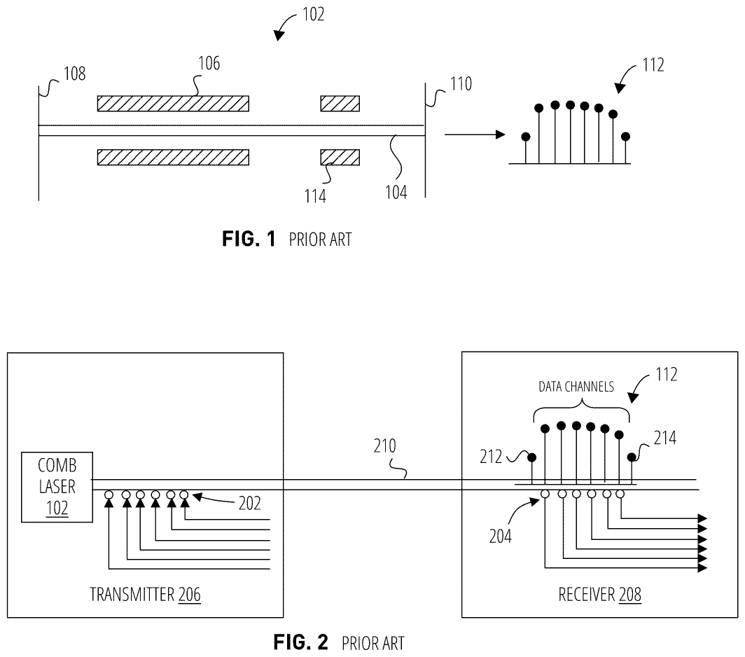

Comb lasers are utilized in photonic systems to generate light spectra comprising multiple power peaks at evenly spaced intervals in the spectra. FIG. 1 depicts a simplified diagram of internal components of a comb laser 102 light source, for example a mode-locked laser diode. The comb laser 102 comprises, among other components, a laser cavity 104 in which generation and amplification of light takes place and a gain material 106 (e.g., a semiconductor, fiber, or gas, depending on the type of comb laser) positioned to amplify the light in the laser cavity 104. The comb laser 102 may further comprise a full mirror 108 at one end and a partial mirror 110 at the other end (to pass some of the amplified light from the laser cavity 104 to a light guide, for example).

The comb laser 102 generates an optical spectrum 112 with power peaks at the wavelengths/frequencies that are modulated with data signals.

The comb laser 102 may also comprise a saturable absorber material 114 along the laser cavity 104 to achieve passive mode-locking and the generation of short pulses of light (e.g., in the picosecond or even shorter range). At low light intensities, the saturable absorber material 114 absorbs and attenuates incident light significantly, but as the light intensity increases to a high level, the absorption decreases, allowing more light to pass through. The saturable absorber material 114 functions akin to an intensity-dependent optical switch and may comprise materials such as semiconductors, organic dyes, and crystals, depending on the specific requirements of the laser.

Although not depicted, the comb laser 102 may comprise other components known in the art. Non-limiting examples of such components include (1) a pump source that provides energy to excite the gain medium (e.g., an electrical current or another laser), (2) modulators for one or more of the intensity, phase, or frequency of light to stabilize the output spectra or to generate specific spectral features, nonlinear optical elements such as micro-resonators or nonlinear crystals to generate additional frequencies through processes such as four-wave mixing, (3) dispersion control components such as fiber Bragg gratings or dispersive mirrors that manage the dispersion within the laser cavity, (4) wavelength selective elements such as etalons and diffraction gratings, again for spectral stability, and (5) an electronic control system to monitor and control the laser's output.

In general terms, the shape and power of the optical spectrum 112 generated by the comb laser 102 is determined by the laser line locations in the optical spectrum 112 multiplied by the gain spectrum of the gain material 106.

The spacing of the laser lines is determined by the pulse round trip time, and the laser line wavelengths are determined by the requirement that a round trip in the laser cavity 104 be an integral number of wavelengths.

In response to changes in ambient temperature of the comb laser 102, the entire laser optical spectrum 112 may shift higher or lower in frequency, with the spacing among the laser lines remaining relatively unchanged. However the gain/power distribution among the laser lines may also change with the change in temperature (e.g., due to temperature-sensitive properties of the gain material 106), in manners and rates that differ from temperature-induced frequency shifts in the entire optical spectrum 112.

A change in ambient temperature may cause a shift in the laser lines'wavelengths and also a redistribution of power among the laser lines. The wavelength shift may be readily tracked and compensated for by closed-loop control circuits on the transmitter resonant ring 202 devices and on the downstream receiver resonant ring 204 devices. However the redistribution of power due to the shift in gain spectrum may be problematic. For example the redistribution of power among the data channels may cause one or more to fall below minimum power requirements for maintaining the system's signal-to-noise ratio within acceptable bounds.

FIG. 2 depicts a dense wave division multiplexed (DWDM) transceiver in one embodiment. The transceiver comprises a transmitter 206 coupled to a receiver 208 over a waveguide 210. The data channels of the optical spectrum 112 are centered on laser lines (the peaks in the optical spectrum 112) generated by the comb laser 102 and are modulated with data signals using resonant rings 202 (e.g., micro-ring modulators) at the transmitter end of the waveguide 210. The data channels in the optical spectrum 112 are demultiplexed by resonant rings 204 (e.g., micro-ring resonant filters) at the receiver 208. In addition to the data channels of interest, the optical spectrum 112 also includes a lower sideband channel 212 and an upper sideband channel 214 that do not carry data.

A micro-ring modulator and a micro-ring resonant filter (also called a ‘drop ring’) are both devices that exploit the resonant properties of optical resonators but serve different purposes in optical systems. A micro-ring modulator is a device used to modulate the intensity, phase, or frequency of light passing through it, based on the input electrical signals. It incorporates a micro-ring resonator next to a waveguide. When light enters the system, part of it couples into the micro-ring and interferes with incoming light. By applying an electrical signal, the refractive index of the micro-ring is changed, altering the resonant condition of the ring. This modulation affects how much light is transmitted through the waveguide, allowing the micro-ring modulator to encode information onto an optical signal for applications in optical communication systems.

Micro-ring resonant filters, on the other hand, are designed to selectively transmit or drop specific wavelengths of light. These devices utilize a micro-ring resonator coupled to one or more waveguides. Light traveling through the waveguide interacts with the micro-ring; only wavelengths that match the resonant condition of the ring can efficiently couple into and circulate within the ring, being either dropped to another waveguide or removed from the main waveguide, thereby filtering out specific wavelengths.

Each of the resonant rings 202 may be assigned to modulate data onto a different laser line, and each of the resonant rings 204 may be tuned to a filter and drop the signal modulated on a particular one of the laser lines. The corresponding resonant rings in the transmitter 206 and the receiver 208 may have their resonant frequencies locked and matched in a closed-loop control circuit to track any shifts in the laser line's wavelength due to temperature drift or other factors.

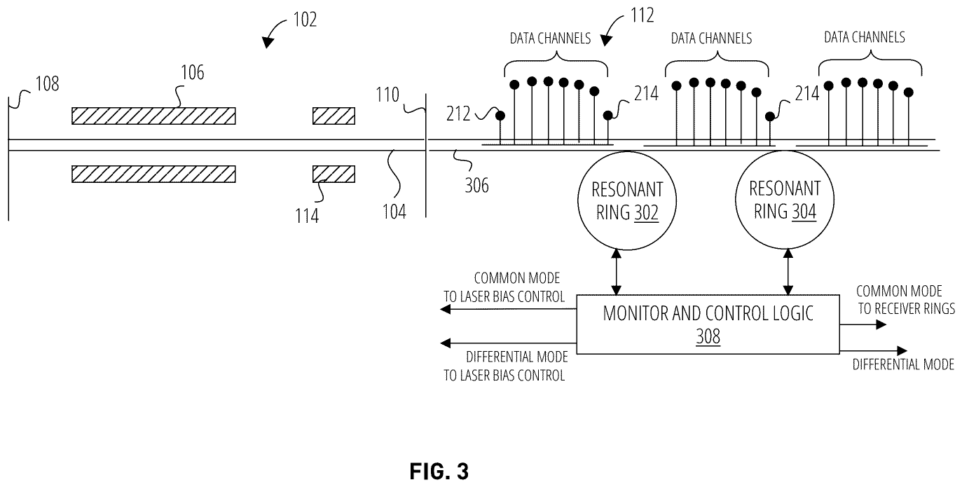

FIG. 3 depicts an embodiment in which tunable resonant rings 302, 304 are disposed along a waveguide 306 at an output of a comb laser 102. The resonant rings 302, 304 may be disposed along the waveguide 306 in the order shown or the order may be swapped. This example depicts two resonant rings but more than two may be utilized in other embodiments.

The monitor and control logic 308 tunes and locks a resonant frequency of the resonant ring 302 to the lower sideband channel 212, and tunes and locks a resonant frequency of the resonant ring 304 to the upper sideband channel 214.

A side mode of a resonator refers to any of the additional resonance frequencies or modes that occur at frequencies other than the primary or desired resonant frequencies of the data signal carriers. These side modes represent optical frequencies that resonate within the laser cavity 104 in addition to the laser line modes. Mode locking within the comb laser 102 may reduce the power of these side modes relative to the desired laser lines, but substantial power may remain in the side modes, especially the two “dominant” side modes closest to the band of the optical spectrum 112 that carries the data signals.

Each ring is equipped with a (not depicted) tuner (e.g., resistive thermal heating element, a semiconductor heating element, or a free-carrier dispersion element) that is operated in a control loop by the monitor and control logic 308 to lock the resonance frequency of each ring to the respective sideband, in manners known in the art.

The dominant side modes of the laser may introduce crosstalk or otherwise deteriorate the signal quality of the data channels. The resonant rings 302, 304 operate as drop rings to suppress the power of the two dominant crosstalk-aggressor sideband channels and thus reduce these effects.

Each of the resonant rings 302, 304 also comprises a power monitoring mechanism such as a drop port or diode (not depicted). The monitor and control logic 308 utilizes these monitoring elements to obtain readings of the wavelengths and powers of the dominant sidebands of the data channel optical spectrum 112.

A common mode signal (a common movement to both sidebands) is obtained from these readings. Any operating factor that affects both sidebands equally and in the same direction is a common mode signal. The wavelength information about the two sidebands is always common mode, at least in response to changes in ambient temperature effects, because the two sidebands (and indeed the entire optical spectrum 112) move together in the same direction and by the same amount with changes in ambient temperature.

The common mode signal of the sideband wavelength informs about the magnitude and direction of any shift that is occurring in the laser lines of the data channels. The common mode amplitude signal of the sidebands informs on the power in the data channels, because a common mode decrease in the amplitude of the sidebands will also be reflected in a similar change in the power delivered by the laser to the data channels. This common mode amplitude signal may be utilized to compensate for power drop-off in the laser output due to aging or other factors by adjustments (e.g., increases) in the laser bias current. The common mode wavelength information may be communicated to resonance tuning logic for the resonant rings 204 in the receiver to compensate for wavelength shifts in the laser lines of the data channels.

The amplitude (power) signal for the two sidebands may also comprise a differential mode. For example the lower sideband channel 212 may be trending toward higher power while the upper sideband channel 214 may be trending toward lower power, which may indicate that data channels closer to the upper sideband channel 214 are also trending lower in power. Alternatively the lower sideband channel 212 may be trending toward lower power while the upper sideband channel 214 may be trending toward higher power, which may indicate that data channels closer to the lower sideband channel 212 are also trending lower in power. The differential mode signal of the sidebands informs about a direction that the gain region spectrum is evolving and may be applied to pre-emptively reassign (retune) the resonant rings 204 of the receiver away from resonating on laser lines that are trending toward a power level below the signal-to-noise ratio requirement of the application, and/or to adjust the laser bias and environmental conditions.

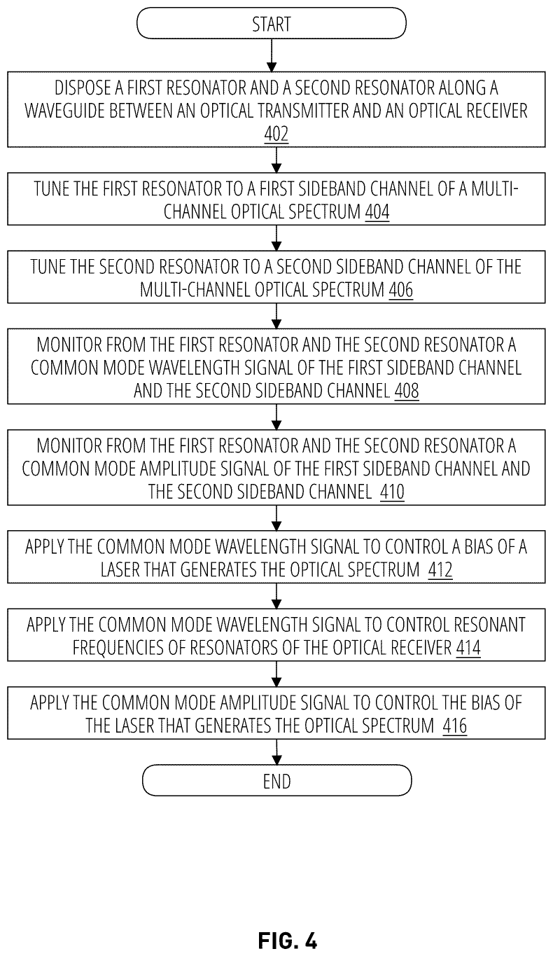

FIG. 4 depicts an embodiment of a process for controlling laser bias and/or resonator frequencies in accordance with common mode signals for sideband channels. At 402 a first resonator and a second resonator are disposed (placed) along a waveguide between an optical transmitter and an optical receiver. At 404 the first resonator is tuned to a first sideband channel of a multi-channel optical spectrum. At 406 the second resonator is tuned to a second sideband channel of the multi-channel optical spectrum.

At 408 the first resonator and the second resonator are monitored for a common mode wavelength signal of the first sideband channel and the second sideband channel. At 410 the first resonator and the second resonator are monitored for a common mode amplitude signal of the first sideband channel and the second sideband channel.

At 412 the common mode wavelength signal is applied to control (at least) a bias of a laser that generates the optical spectrum. At 414 the common mode signal is applied to control (at least) resonant frequencies of resonators of the optical receiver, e.g., to maintain the resonant frequencies of the resonant rings 204 of the receiver 208 synchronized to the resonant frequencies of corresponding ones of the resonant rings 202 in the transmitter 206. At 416 the common mode amplitude signal may also applied to control (at least) the bias of the laser that generates the optical spectrum.

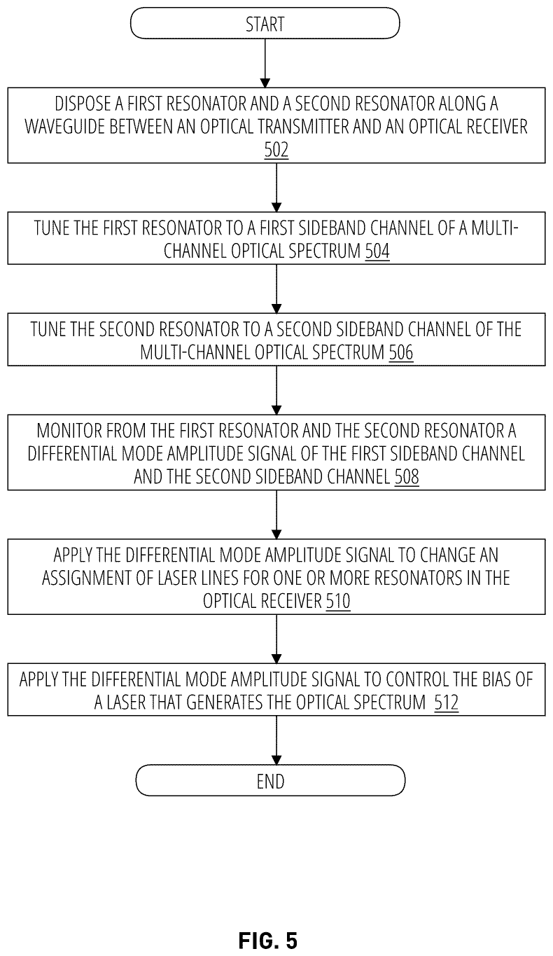

FIG. 5 depicts an embodiment of a process for controlling laser bias and/or resonator frequencies in accordance with differential mode signals for sideband channels.

At 502 a first resonator and a second resonator are disposed (placed) along a waveguide between an optical transmitter and an optical receiver. At 504 the first resonator is tuned to a first sideband channel of a multi-channel optical spectrum. At 506 the second resonator is tuned to a second sideband channel of the multi-channel optical spectrum.

At 508 the first resonator and the second resonator are monitored for a differential mode amplitude signal of the first sideband channel and the second sideband channel. At 510 the differential mode amplitude signal is applied (at least) to change an assignment of laser lines for one or more resonators in the optical receiver, and at 512 the differential mode amplitude signal may be applied to control (at least) the bias of a laser that generates the optical spectrum. In some embodiments, the differential mode amplitude signal may be applied to control the gain applied at the receiver for particular channels, e.g., to control the gain of particular drop rings 204 in the receiver, and/or the modulator rings 202 of the transmitter.

In one embodiment a laser line reassignment may be undertaken for one or more of the receiver resonant rings 204 upon detecting that a signed rate of change of the differential mode signal is approaching, meeting, or exceeding a configured threshold value. Alternatively or additionally, a laser line reassignment may be undertaken for one or more of the receiver resonant rings 204 upon detecting that a signed magnitude the differential mode signal is approaching, meeting, or exceeding a configured threshold value. In either case the sign may determine whether reassignment is applied to one or more of the resonant rings 204 closer to the lower sideband channel 212 or the upper sideband channel 214.

### LISTING OF DRAWING ELEMENTS

102 comb laser
104 laser cavity
106 gain material
108 full mirror
110 partial mirror
112 optical spectrum
114 saturable absorber material
202 resonant ring
204 resonant ring
206 transmitter
208 receiver
210 waveguide
212 lower sideband channel
214 upper sideband channel
302 resonant ring
304 resonant ring
306 waveguide
308 monitor and control logic
402 process action
404 process action
406 process action
408 process action
410 process action
412 process action
414 process action
416 process action
502 process action
504 process action
506 process action
508 process action
510 process action
512 process action

Various functional operations described herein may be implemented in logic that is referred to using a noun or noun phrase reflecting said operation or function. For example, an association operation may be carried out by an “associator” or “correlator”. Likewise, switching may be carried out by a “switch”, selection by a “selector”, and so on. “Logic” refers to machine memory circuits and non-transitory machine readable media comprising machine-executable instructions (software and firmware), and/or circuitry (hardware) which by way of its material and/or material-energy configuration comprises control and/or procedural signals, and/or settings and values (such as resistance, impedance, capacitance, inductance, current/voltage ratings, etc.), that may be applied to influence the operation of a device. Magnetic media, electronic circuits, electrical and optical memory (both volatile and nonvolatile), and firmware are examples of logic. Logic specifically excludes pure signals or software per se (however does not exclude machine memories comprising software and thereby forming configurations of matter). Logic symbols in the drawings should be understood to have their ordinary interpretation in the art in terms of functionality and various structures that may be utilized for their implementation, unless otherwise indicated.

Within this disclosure, different entities (which may variously be referred to as “units,” “circuits,” other components, etc.) may be described or claimed as “configured” to perform one or more tasks or operations. This formulation—[entity] configured to [perform one or more tasks]—is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “credit distribution circuit configured to distribute credits to a plurality of processor cores” is intended to cover, for example, an integrated circuit that has circuitry that performs this function during operation, even if the integrated circuit in question is not currently being used (e.g., a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to”perform that function after programming.

Reciting in the appended claims that a structure is “configured to” perform one or more tasks is expressly intended not to invoke 35 U.S.C. § 112(f) for that claim element.

Accordingly, claims in this application that do not otherwise include the “means for” [performing a function] construct should not be interpreted under 35 U.S.C § 112(f).

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. For example, in a register file having eight registers, the terms “first register” and “second register” can be used to refer to any two of the eight registers, and not, for example, just logical registers 0 and 1.

When used in the claims, the term “or” is used as an inclusive or and not as an exclusive or. For example, the phrase “at least one of x, y, or z” means any one of x, y, and z, as well as any combination thereof.

As used herein, a recitation of “and/or” with respect to two or more elements should be interpreted to mean only one element, or a combination of elements. For example, “element A, element B, and/or element C” may include only element A, only element B, only element C, element A and element B, element A and element C, element B and element C, or elements A, B, and C. In addition, “at least one of element A or element B” may include at least one of element A, at least one of element B, or at least one of element A and at least one of element B. Further, “at least one of element A and element B” may include at least one of element A, at least one of element B, or at least one of element A and at least one of element B.

Although the terms “step” and/or “block” may be used herein to connote different elements of methods employed, the terms should not be interpreted as implying any particular order among or between various steps herein disclosed unless and except when the order of individual steps is explicitly described.

Having thus described illustrative embodiments in detail, it will be apparent that modifications and variations are possible without departing from the scope of the intended invention as claimed. The scope of inventive subject matter is not limited to the depicted embodiments but is rather set forth in the following Claims.

What is claimed is:

1. A system comprising:
a first resonator and a second resonator disposed along a waveguide at an output of at least one laser configured to generate a multi-channel optical spectrum;
logic configured to:
tune the first resonator to a first sideband channel of a multi-channel optical spectrum;
tune the second resonator to a second sideband channel of the multi-channel optical spectrum;
monitor the first resonator and the second resonator for a common mode wavelength signal of the first sideband channel and the second sideband channel; and
apply the common mode wavelength signal to control resonant frequencies of resonators of an optical receiver.

2. The system of claim 1, wherein the logic is further configured to:
monitor the first resonator and the second resonator for a common mode amplitude signal of the first sideband channel and the second sideband channel.

3. The system of claim 2, wherein the logic is further configured to:
apply the common mode amplitude signal to control a bias of the at least one laser.

4. The system of claim 1, wherein the logic is further configured to:
monitor the first resonator and the second resonator for a differential mode amplitude signal of the first sideband channel and the second sideband channel; and
apply the differential mode amplitude signal to change an assignment of laser lines for one or more resonators in the optical receiver.

5. The system of claim 4, wherein the change in assignment of the laser lines is based on a rate of change of the differential mode amplitude signal.

6. The system of claim 4, wherein the change in assignment of the laser lines is based on a signed magnitude of the differential mode amplitude signal.

7. The system of claim 1, wherein the logic is further configured to:
monitor the first resonator and the second resonator for a differential mode amplitude signal of the first sideband channel and the second sideband channel; and
apply the differential mode amplitude signal to control a bias of the at least one laser.

8. The system of claim 1, wherein the at least one laser comprises a comb laser.

9. A method comprising:
disposing a first resonator and a second resonator along a waveguide between an optical transmitter and an optical receiver;
tuning the first resonator to a first sideband channel of a multi-channel optical spectrum;
tuning the second resonator to a second sideband channel of the multi-channel optical spectrum;
monitoring from the first resonator and the second resonator a common mode wavelength signal of the first sideband channel and the second sideband channel; and
applying the common mode wavelength signal to control resonant frequencies of resonators of the optical receiver.

10. The method of claim 9, further comprising:
monitoring from the first resonator and the second resonator a common mode amplitude signal of the first sideband channel and the second sideband channel; and
applying the common mode amplitude signal to control a bias of a laser.

11. A method comprising:
disposing a first resonator and a second resonator along a waveguide between an optical transmitter and an optical receiver;
tuning the first resonator to a first sideband channel of a multi-channel optical spectrum;
tuning the second resonator to a second sideband channel of the multi-channel optical spectrum;
monitoring from the first resonator and the second resonator a differential mode amplitude signal of the first sideband channel and the second sideband channel; and
applying the differential mode amplitude signal to change an assignment of laser lines for one or more resonators in the optical receiver.

12. The method of claim 11, further comprising:
applying the differential mode amplitude signal to control a bias of a laser.

13. A system comprising:
a first resonator and a second resonator disposed along a waveguide at an output of at least one laser configured to generate a multi-channel optical spectrum;
logic configured to:
tune the first resonator to a first sideband channel of a multi-channel optical spectrum;
tune the second resonator to a second sideband channel of the multi-channel optical spectrum;
monitor the first resonator and the second resonator for a differential mode amplitude signal of the first sideband channel and the second sideband channel; and
apply the differential mode amplitude signal to change an assignment of laser lines for one or more resonators in an optical receiver.

14. The system of claim 13, wherein the logic is further configured to:
monitor the first resonator and the second resonator for a common mode wavelength signal of the first sideband channel and the second sideband channel; and
apply the common mode wavelength signal to control resonant frequencies of resonators of an optical receiver.

15. The system of claim 13, wherein the logic is further configured to:
monitor the first resonator and the second resonator for a common mode amplitude signal of the first sideband channel and the second sideband channel; and
apply the common mode amplitude signal to control a bias of the at least one laser.

16. The system of claim 13, wherein the logic is further configured to:
apply the differential mode wavelength signal to control a bias of the at least one laser.

17. The system of claim 13, wherein the change in assignment of the laser lines is based on a rate of change of the differential mode amplitude signal.

18. The system of claim 13, wherein the change in assignment of the laser lines is based on a signed magnitude of the differential mode amplitude signal.

19. The system of claim 13, wherein the logic is further configured to:
monitor the first resonator and the second resonator for a differential mode amplitude signal of the first sideband channel and the second sideband channel; and
apply the differential mode amplitude signal to control a bias of the at least one laser.

20. The system of claim 13, wherein the at least one laser comprises a comb laser.
